(19) United States
(12) Patent Application Publication
(10) Pub. No.: US 2005/0166568 A1
(43) Pub. Date: Aug. 4, 2005

(54) Split-level deflector for harvested tree-fruit

(75) Inventors: Eitan Zehavi, Kiryat Tivon (IL); David Chiel, Afula Illit (IL)

Correspondence Address: FRISHAUF, HOLTZ, GOODMAN & CHICK, PC, 220 5TH AVE FL 16, NEW YORK, NY, 10001-7708, US

(73) Assignee: DOTAN LTD., Migdal Haemek (IL)

(21) Appl. No.: 11/057,933

(22) Filed: Feb. 14, 2005

Related U.S. Application Data
(63) Continuation of application No. PCT/IL03/00697, filed on Aug. 25, 2003.
(60) Provisional application No. 60/405,923, filed on Aug. 26, 2002.

(51) Int. Cl. A01D 46/22

(52) U.S. Cl. 56/329

(57) ABSTRACT

A split-level flexible deflector, or SLFD, supported above a telescopic boom carrying a tree-trunk shaker, and having an upper portion (103, 203) and a lower portion, which is divided in a mid-section residing above the telescopic boom, with on both sides thereof, two side portions positioned lower below the mid-section and proximate to the ground (G). The proximity of each one of the two side portions to the ground is independently adjustable. The SLFD is configured for assembly and disassembly in situ, into man-portable divisions. The mid-division is foldable. The SLFD is carried by a towed vehicle, which is pulled with a towing boom behind an automotive vehicle. Optionally, the SLFD is supported on the automotive vehicle.

This application is a Continuation of PCT/IL03/000697, filed 26.08.2002 Aug. 26, 2002.

### BACKGROUND OF THE INVENTION

The present invention relates in general to the harvesting of fruit from trees, and in particular, to equipment for deflecting, thus receiving and guiding fruit harvested from a tree by a tree-shaking harvester, towards fruit collection equipment.

During the last decades, economic pressure forced the development of mechanized tree-fruit harvesting machinery aimed at diminishing harvesting expenses and rising overall harvesting efficiency. The present applicant divulged implementations and elements of such harvesting systems, such as for a tree shaking and harvesting apparatus in U.S. Pat. No. 5,469,695, and for a deflector for a tree-fruit harvester in a co-pending PCT Patent Application published as International Publication No. WO 02/089556, referred to below as the '556 application, which is incorporated herewith in whole by reference.

FIGS. 1 and 2 are, respectively, a side view and a top view of a prior art conventional tree harvesting system operating the deflector of the '556 application. Tree-fruit TRF, or fruit TRF, is harvested from the foliage FOL of a tree T by use of a tree-trunk shaker 9 clamped onto and for shaking the tree-trunk TT that protrudes above the ground G. There is schematically shown an automotive vehicle 11, or self-propelled platform 11, supporting a boom harvester 13 and a flexible deflector 15, or deflector 15. The boom harvester 13 has a telescopic boom 17 with a static portion 19 cantilevered to a vehicle, such as the automotive vehicle 11. The deflector is coupled in perpendicular to a translating portion of the telescopic boom 17, which also supports a tree-fruit harvesting unit 9.

For the sake of orientation, front F indicates the direction opposite to the forward motion of the automotive vehicle 11, while rear R or back designates the contrary direction. A fruit collection system COL, shown only in FIG. 1, is located on a first row-side FRR of the tree T, with the deflector 15 residing on a second row-side SCR thereof. On the second row-side SCR, proximal refers to the direction closer to the tree T, or row of trees ROT, while distal relates to the direction away from the tree.

The extensible and retractable movable portion of the telescopic boom 17 supports both the deflector 15, as well as a tree-trunk shaker 9, which is coupled to the free extremity 21 of the telescopic boom 17. The deflector 15 is mounted to the mobile portion, that is, to the retractable and extensible portion of the telescopic boom 17 by an attachment support 23, behind, thus away from the free extremity 21, and higher above the tree-trunk shaker 9. Moreover, the deflector 15 has a central indentation 25, or cutout 25, on the leading edge, arranged for penetration therein of the tree-trunk TT.

The entire surface of the flexible deflector 15, which receives the fruit TRF, is covered with flexible pliable material covering the interstices of the ribs of the flexible deflector, to maximize the effective fruit collection surface and soften the impact of the falling fruit TRF. The vibrations generated by the tree-trunk shaker 9 enhance the groundward descent of the fruit TRF received on the deflector 15.

The tree-trunk shaker 9 hides a vibration unit 27, mounted, for example, inside one of the two clamping jaws 29. It is noted that the deflector 15 is translate by the telescopic boom 17 from a position where the proximal edge 33 of the indentation 25 is proximate the tree-trunk TT, up to where the distal portion 35 of the deflector 15 almost abuts the automotive vehicle 11.

In the description below similar reference numerals and reference characters refer to similar elements in the various Figs.

### DISCLOSURE OF THE INVENTION

The '556 application teaches a resilient and flexible deflector able to survive collisions with branches, with obstacles on the ground, and even with tree trunks. However, the '556 application does not solve the problem of how to engage the flexible deflector 15 low enough to penetrate below the foliage FOL of the harvested tree, close enough to the ground G to avoid low hanging branches, such as sagging branches heavy with fruit. Since the flexible deflector 15 is mounted above the vibration unit, thus above the telescopic boom, as one unitary device of uniform height above the ground G, it is impossible to penetrate under the foliage of a tree lower than the height above the ground of the vibration unit.

Another problem with the '556 application is that the driver D, or operator D, of the equipment, is seated on the automotive vehicle behind the flexible deflector facing the tree T, and has his view obstructed by the flexible deflector itself. Therefore, collisions of the flexible deflector with the tree-trunk TT often occur. Furthermore, the positioning of the vibration unit and clamping of the tree-trunk TT is laborious due to the lack of a clear and unobstructed line of sight, so that long and precious time is wasted in unproductive maneuvering caused by visibility hindrances.

Moreover, after harvesting of the tree T, the retraction path of the flexible deflector, distally away from the tree T, is limited by the height and the width of the self-propelled vehicle, making it many times difficult to proceed from one tree to another without intricate maneuvers.

A last drawback is that the overall length of the flexible deflector, some 6 m long, poses difficult transportation problems to and from the field.

It is therefore accepted that in the field application and logistics necessities require a deflector of different configuration. The above-listed deficiencies are remedied by the present disclosure, which provides a split-level flexible deflector SLFD, as shown in FIGS. 3 and 4.

At first sight, the split-level flexible deflector (SLDF) divulged below seems similar to the flexible deflector of the '556 application, since it also features an upper portion and a lower portion. However, the lower portion of the SLFD is easily distinguished by having one mid-section located at a higher level of height, above the telescopic boom, while a front section and a rear section, which are the side sections, mounted to both sides of the mid-section, reside at a lower level of height, to facilitate penetration below low hanging branches of a tree T. In other words, each section has a leading edge, but the leading edge of each one of the two side sections is closer to the ground at a vertically spaced apart distance below and away from the leading edge of the mid-section.

Another advantage of the SLFD is the ability to adjust the height above the ground G of the leading edge of the front and the rear sections.

Then, to help the driver have an unobstructed line of sight from his seat to the vibration unit, the SLDF is mounted on a towed vehicle, or a cart towed by a towing boom coupled to an automotive vehicle, or towing vehicle, on which the driver is seated. The towed vehicle is configured as a low-height and narrow cart with small wheels, thus without a high-riding driver's cabin and without huge tractor wheels, much lower above the ground than the self-propelled vehicle, or than the towing vehicle. Therefore, the split-level flexible deflector SLFD may retract much further distally away from the tree T, thus along a longer retraction path than with the '556 application. The towed vehicle is not limited to two wheels, as for a cart, but may have more wheels, like four wheels for example.

Finally, to ease transportation, the split-level flexible deflector SLFD may be disassembled into man-transportable portions, loaded onto the towing boom and transported to and away from the field.

### BRIEF SUMMARY OF THE INVENTION

It is an object of the present invention to provide a split level flexible deflector, or SLFD, and a method for implementing a split level flexible deflector having an upper portion and a lower portion configured for receiving and guiding fruit toward the ground (G), the SLFD being coupled in perpendicular to a translating portion of a telescopic boom supporting a tree-trunk shaker and having a static portion cantilevered to a vehicle. The SLFD comprises configuring the lower portion of the SLFD as three substantially aligned sections having one mid-section and one side section on each one of the two sides of the mid-section, each one section having a leading edge, and
positioning the leading edge of each one of the two side sections closer to the ground at a vertically spaced apart distance below and away from the leading edge of the mid-section,
whereby the leading edge of each one of the two side sections resides at a selected level of height above the ground and closer thereto, and lower below the level of the leading edge of the mid-section.

It is another object of the present invention to provide an SLFD configured to allow selection and independent adjustment of the level of height above the ground of the leading edge of each one of the side-sections. It is an additional object of the present invention to provide an SLFD wherein the vehicle is selected as a towed vehicle, the telescopic boom is configured for coupling in cantilever to the towed vehicle, and the towed vehicle is pulled with a towing boom behind an automotive vehicle.

It is yet an object of the present invention to provide an SLFD wherein the length of the towing boom is adapted appropriately to provide an operator seated on the automotive vehicle with a view unobstructured by the upper portion of the SLFD, and the operator is provided with a free line of sight to allow visual observation of the tree-trunk shaker mounted on the telescopic boom.

It is yet an object of the present invention to provide an SLFD wherein the SLFD is configured to have three separable substantially aligned divisions with one mid-division and one side-division on each one of the two sides of the mid-division, each one of the two side-divisions is configured for in situ assembly to, and for in situ disassembly from, the mid-division, and the towing boom is configured for transportation thereon of the side divisions.

It is yet another object of the present invention to provide an SLFD wherein the SLFD is configured into three separable substantially aligned divisions comprising one mid-division and one side-division on each one of the two sides of the mid-division, and each one of the two side-divisions is configured for in situ assembly to, and for in situ disassembly from, the mid-division.

It is yet another object of the present invention to provide an SLFD wherein each one side division is coupled to the mid-division with fast-assembly and fast-disassembly fastening elements, whereby fast assembly and disassembly of each one of the side divisions is provided. Furthermore, each one of the side-divisions is configured as a man-portable division.

It is still another object of the present invention to provide an SLFD wherein the mid-division has a mid-section pertaining to the lower portion and a mid-wall pertaining to the upper portion, and the mid-section is coupled in pivotal retention relative to the mid-wall, whereby the mid-division is foldable by pivoting thereof onto the mid-wall.

It is still one more object of the present invention to provide an SLFD wherein the the telescopic boom supporting the SLFD is coupled in cantilever to a towed vehicle pulled by a towing boom hitched to an automotive vehicle, the towing boom is configured for transportation thereon of the side divisions, each one of the side-divisions is disassembled from the mid-division, which is then folded, and the side-divisions is loaded onto the towing boom, whereby the SLFD is accommodated for transportation.

### BRIEF DESCRIPTION OF THE DRAWINGS

In order to understand the invention and to see how it may be carried out in practice, preferred embodiments will now be described, by way of non-limiting example only, with reference to the accompanying drawings, in which:

FIG. 1 illustrates a side view of a prior art conventional tree harvesting system,

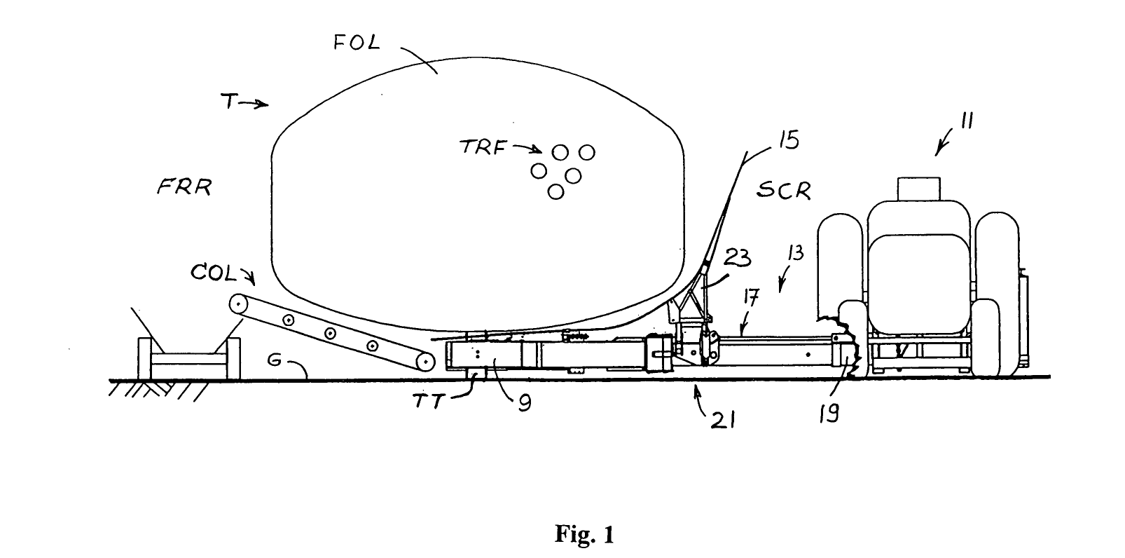

FIG. 2 depicts a top view of the prior art system shown in FIG. 1, but without the collection equipment,

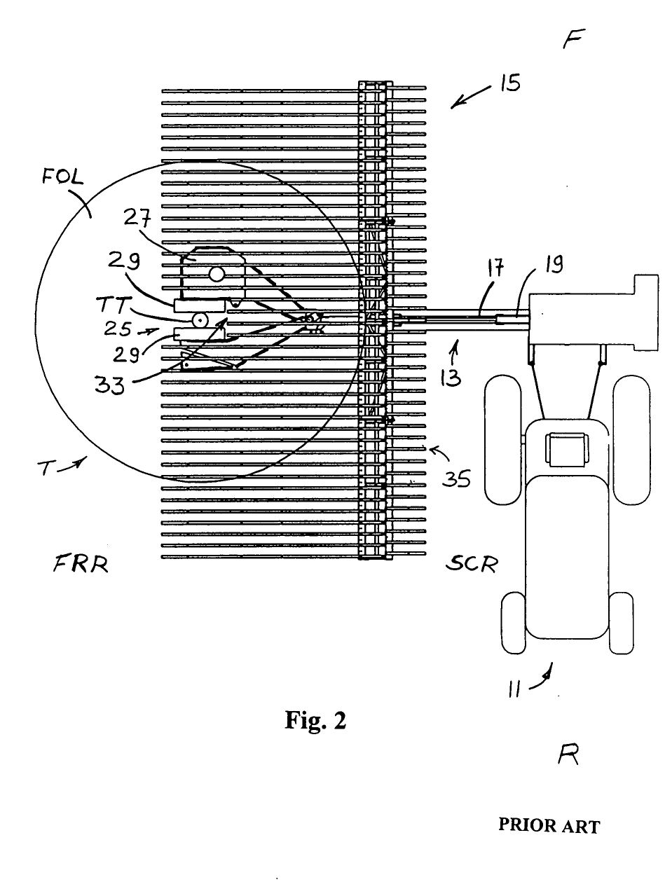

FIG. 3 presents a first embodiment 100 a the split-level flexible deflector,

FIG. 4 shows a second embodiment 200 of the split-level flexible deflector,

FIG. 5 features the backbone of the second embodiment shown in FIG. 4, which is constructed as a built beam made of three assembled beam segments,

FIG. 6 shows a cross-section of only the mid-division of the second embodiment shown in FIG. 4, and

FIG. 7 is a top view of the second embodiment shown in FIG. 4, when mounted on a towed vehicle.

### DETAILED DESCRIPTION OF THE INVENTION

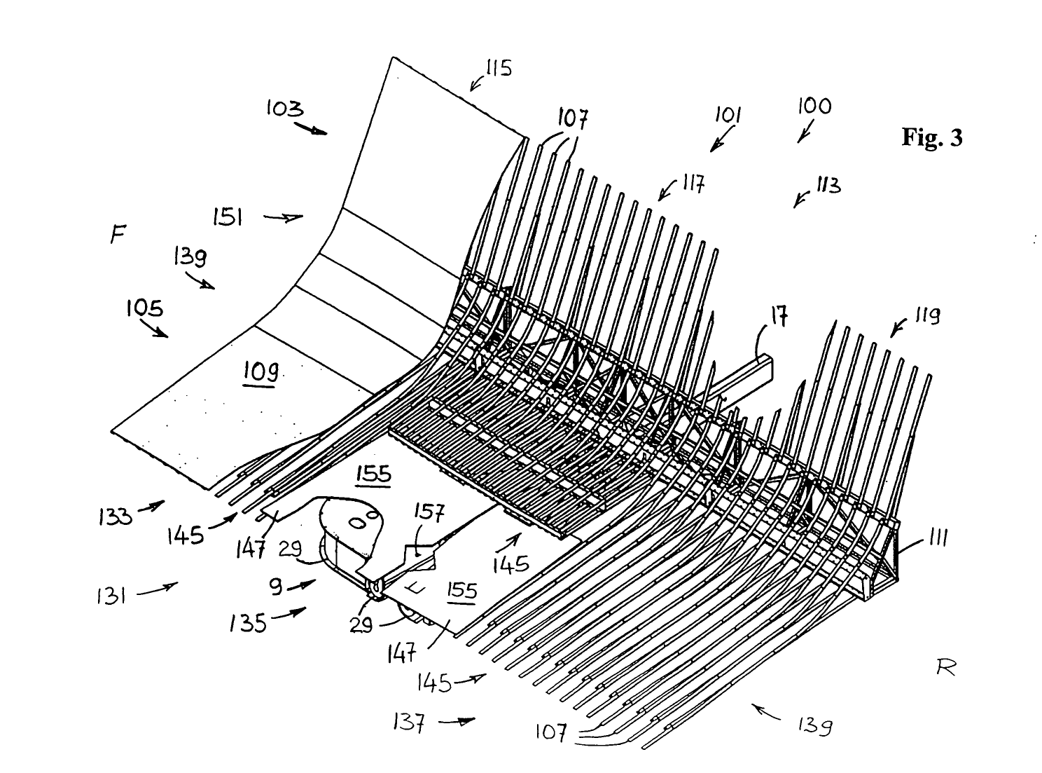

With reference to FIGS. 3 to 7, the disclosed split-level flexible deflector SLFD takes advantage of the principles taught in the '556 application, regarding structure configuration and resilient flexibility.

### First Embodiment 100

FIG. 3 illustrates a first embodiment 100 of the split-level flexible deflector 101, or SLFD 101 for short. As with the flexible deflector 15, the SLFD 101 has an upper portion 103 and lower portion 105 made of flexible ribs 107, covered, if desired or if necessary, with a surface cover 109, shown only partially in FIG. 3. When the distance between the ribs 107 of the SLFD 101 is spaced so far apart that fruit TRF slips between ribs, then, the surface of the SLFD needs a surface cover 109. Both the upper portion 103 and lower portion 105 are cantilevered to a backbone structure 111. The SLFD 101 is coupled to and supported by the telescopic boom 17, in the same manner as taught in the '566 disclosure. It is noted that a portion of the upper portion 103 of the SLFD 101 is cut open to show the telescopic boom 17. As known in the art, the surface cover 109 is either a net or plain without meshes.

The SLFD 101 may be regarded as being made of three consecutively and substantially aligned divisions 113, namely a front division 115, a mid-division 117 and a rear division 119.

With the embodiment 100, the entire device is unitary, and the upper portion 103 forms a single coplanar wall.

The lower portion 105 of the SLFD 101 is divided into at least three sections 131, namely a front section 133, a mid-section 135 and a rear section 137. The divisions 113 may be considered as the columns of a matrix, where the row s are the upper portion 103 and the lower portion 105. Both the front section 133 and the rear section 137, defined as the side sections 139, have ribs 107 which are longer, when measured from the backbone 111 to a section leading edge 145, when compared to the length of the ribs 107 of the mid-section 135. Therefore, the leading edge 145 of the mid-section 135 reaches only to proximate the tree-trunk shaker 9, but above thereof, at a level higher away from the ground G.

Although the sections 131 all slope groundward, the mid-section 135 is elevated higher above, relative to the side sections 139. In other words, since the side sections 139 are positioned at a lower level below the upper level of the mid-section 135, these side sections 139 will easily pass below the lower branches of a harvested tree T when the tree-trunk shaker 9 approaches the tree T to be harvested. Care is taken to hold the lower level of the side sections 139 low above the ground G but slightly above the collection system COL operating on the opposite side of the tree T, since the SLDF 101 has to deflect fruit TRF from the side of the tree with the SLDF 101 toward the side of the tree with the collection equipment.

Conventional collection equipment, such as disclosed by Zehavi and al. in U.S. Pat. No. 5,469,695, is positioned at a certain height above the level of the ground G. However, in a new collection system divulged in the International Application No. PCT/IL03/00542, or the '542 application for short, filed by Chiel et al., and bearing the International filing date of Jun. 26, 2003, which is incorporated herewith in whole by reference, the newly disclosed collection system has a fruit TRF collection apron A with a portion thereof spread directly on the ground G. Therefore, the lower level of the side sections 139 may reside practically just above the ground G, on top of the apron A, at a minimal distance above the apron, thus proximate the ground G.

As described below, the tree-trunk shaker 9 is shielded from above by a flexible deflector structure, not shown in the Figs., or by a planar deflecting cover 147. The deflecting cover 147 is of about the same width and the same slope as the mid-section 135, and starts from under the mid-section 135 to end in alignment with the leading edge 145 of the side sections 139. This means that when the tree-trunk shaker 9 is clamped on the tree-trunk TT and shakes the tree T for harvesting, the leading edge 145 of all the three sections 131 and of the deflecting cover 147 reach to the opposite side of the tree T. Thus, when the SLFD 101 is positioned on the second row-side SCR of a row of trees (ROT), not shown in the Figs., then the leading edge 145 of all the sections 131 and of the deflecting cover 147 pass to the first row-side FRR, to deflect the fruit TRF toward the collection system.

The flexible and pliable surface cover 109 that covers the ribs 107 and receives the fruit TRF, made either meshed or plain, is preferably smooth with a low coefficient of friction, to ease rolling and guidance groundward of small-mass fruit TRF. Preferably, a canvas, a sheet of plastic material, or a tarpaulin is a possible choice, but other materials will suffice, as long as the surface cover 109 is rather taut. Evidently, the vibrations propagated from the tree-trunk shaker 9 enhance the groundward movement of the fruit TRF.

The parallel ribs 107 of the SLFD 101 are spaced apart, if desired, at equally distributed distance much farther away from each other than with the '556 application since it is the surface cover 109 on top of the entire deflecting surface 151 of the SLFD 101, thus both the upper portion 103 and the lower portion 105, that receive the impact of the fruit TRF. For small-mass fruit TRF, the ribs 107 may be spaced apart much more, such as for olives and almonds, than for citrus fruit, which are heavier.

The inclined deflecting cover 147 is positioned above the tree-trunk shaker 9, in continuous incline, starting from below the mid-section 135 substantially parallel thereto if desired, and groundward. Therefore, fruit TRF landing on the mid-section 135 will continue to roll therefrom over the deflecting cover 147 and to the ground G.

The deflecting cover 147 is made of rigid material, semi-rigid material, pliable material, foamed material, or a combination thereof. Rigid material is sheet metal, engineering plastic, such as fiberglass or polycarbonate. Semi-rigid material is soft plastic, industrial rubber sheet, and elastomeric material. Pliable material is soft rubber and soft elastomeric material. Any combination of rigid, semi-rigid, soft, and foamed material is possible.

The tree-trunk shaker 9 has two opposite openable and closeable jaws 29, for clamping the tree-trunk TT. One separate flat panel 155 is coupled to and covers each jaw 29, with the size of the panel 155 conforming to the size of the corresponding jaw. When the jaws 29 open, they mutually separate and so do the flat panels 155, but when the jaws close on a tree-trunk TT, the flat panels 155 unite, to form a single surface deflecting cover 147. Evidently, the flat panels 155 may overlap.

When the panels 155 are rigid, an opening 157 for the passage of the tree-trunk TT is cut out, as shown in FIG. 3. The opening 157 is polygonal, circular or elliptic, as desired, with one half of the opening in each flat panel 155. When the jaws 29 close, the flat panels 155 also close together, and both opening 157 halves should close and prevent fruit TRF from passing between the tree-trunk TT and the panels. When the panels 155 are made of pliable and resilient material, it suffices to cut radial slits extending away from the tree-trunk TT, not shown in the Figs., that will be forced open to conform to the shape of the periphery of the tree-trunk TT, when the jaws 29 close.

If desired, the SLFD 101 may operate without the deflecting cover 147, but for small-mass and small size fruit TRF, the use of a deflecting cover 147 is preferable.

### Second Embodiment 200

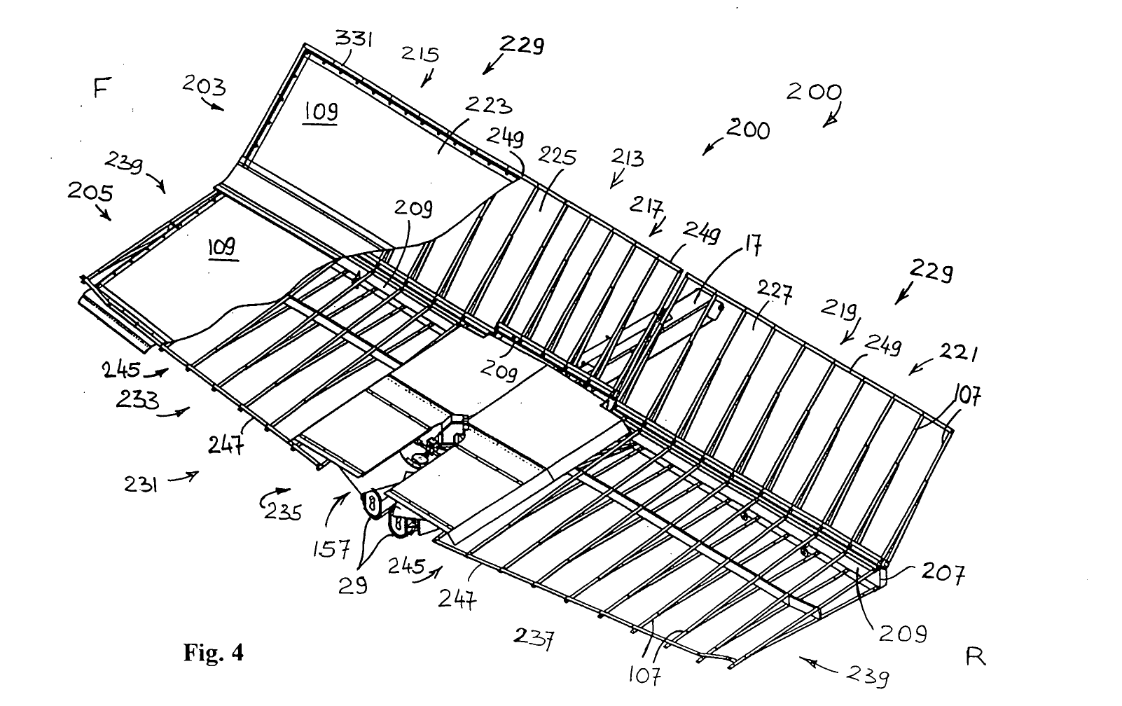

FIG. 4 shows a second embodiment 200 of a SLFD 201, but with most of the surface cover 109 removed to better expose the underlying structure. The SLFD 201 has an upper portion 203 and lower portion 205 with spaced apart flexible ribs 107, covered with a surface cover 109, shown only partly in FIG. 3. The upper portion 203 and the lower portion 205 are cantilevered to a backbone 207 stretching along the whole length of the SLDF 201, which backbone is constructed from hollow beam segments 209. The SLFD 201 is coupled to and supported by the telescopic boom 17, in principle in the same manner, as disclosed in the'556 application, and therefore, such coupling details are not shown in the Figs. In contrast with the embodiment 100, the SLFD 201 is separable into at least three divisions 213, namely a front division 215, a mid-division 217 and a rear division 219. Each division extends to both the upper portion 203 and to the lower portion 205. The upper portion of each division is designated as a wall, and the lower portion of each division is indicated as a section.

The SLFD 201 may be regarded as a matrix with two rows and three columns. The first row is the upper portion 203 and the second row is the lower portion 205, with the divisions 213 as the columns.

With the embodiment 200, each one the divisions 213 are amenable to easy disassembly and assembly in situ. This means that each one of the two side-divisions 229 is accommodated for in situ assembly to, and for in situ disassembly from, the mid-division 217. If desired, each one side division 229 is coupled to the mid-division 217 with fast-assembly and fast-disassembly fastening elements, whereby fast assembly and disassembly of each one of the side divisions is provided. It is noted that the structure of the divisions 213 is lightweight and that therefore, each one of the side-divisions 229, as well as the mid-division 217, is man-portable.

When the divisions 213 are all assembled, their upper portion 203 constitutes practically a wall 221 of co-planar surface, including a front wall 223, a mid-wall 225, and a rear wall 227, corresponding to the upper portion 203 of, respectively, the front division 215, the mid-division 217, and the rear division 219. The front division 215 and the rear division 219 are defined as the side divisions 229. Each wall pertains only to the upper portion 203.

The lower portion 205 is further divided into at least three sections 231, namely a front section 233, a mid-section 235 and a rear section 237, corresponding to, respectively, the front division 215, the mid-division 217, and the rear division 219. Both the front section 233 and the rear section 237, defined as the side sections 239, have ribs 107 on the lower portion which are longer, when measured from the backbone 207 to a section leading edge 245, when compared to the length of the ribs 107 of the mid-section 235, not seen in FIG. 4, similar to those shown in FIG. 3. In the same manner as with the embodiment 100, the mid-section 235 reaches only to proximate the tree-trunk shaker 9, but higher above thereof, at a level of height higher away from the ground G.

Although the sections 231 all slope groundward, the mid-section 235 is elevated above and at a higher level relative to level of height of the side sections 239. In other words, since the side sections 239 are positioned at a lower level of height, below the upper level of height of the mid-section 235, these side sections 239 will be close to the ground G, possibly grazing the ground, to easily pass below the lower branches of a harvested tree T when the tree-trunk shaker 9 is extended toward the tree T, to clamp the tree-trunk TT. Care is taken to maintain the lower level of the side sections 239 higher above the ground G then the collection equipment operating on the opposite side of the tree T, since the SLDF 201 deflects fruit TRF from the one side of the tree where the SLDF 201 operates, toward the other side of the tree with the collection equipment COL.

When the ribs of the SLFD 201 are distanced apart from each other, it is possible to stiffen the structure of the lower portion 203 by adding a leading edge longeron 247 connecting the free-end extremity of the ribs 107, thus connecting the leading edges 245 of each one of the three sections 131. The same is true for the upper portion 203, to which a trailing edge longeron 249 may be added to the free-end extremity of the ribs 107, thus to each one of the front, mid, and rear wall, respectively 223, 225 and 227. When covered with a surface cover 109, the upper portion 203 and the lower portion 205 resemble the wing structure of a light aircraft. Built from fiberglass and clad with a surface cover 109, each section is rather light, and is easily man-portable.

Similarly to a wing, the leading edge 245 of the side sections 239 may be swept distally, toward the backbone 207, to ease penetration under the foliage FOL the harvested tree T. This swept wing configuration is practical with the '542 application, which takes advantage of a fruit collection apron A. The swept wing conforms to the surface of the apron A, which crosses over from the fruit collection side, or first row-side FRR of the tree T, to the SLFD 201 side, or second row-side SCR. It is noted that since the apron A abuts the tree trunk TT, not shown in FIG. 4, there is no need to close the opening 157 but only at the distal end thereof.

The arrangements regarding the surface cover 109 remain essentially the same for the embodiment 200 as those described above for the embodiment 100, but each one of the separate divisions 213 is covered individually. This individual covering of each one of the separate sections 213 is necessary since the embodiment 200 is amenable to disassembly, by disconnection of the front division 215 and of the rear division 219 from the mid-division 217, says for maintenance, for repair, or for transportation purposes.

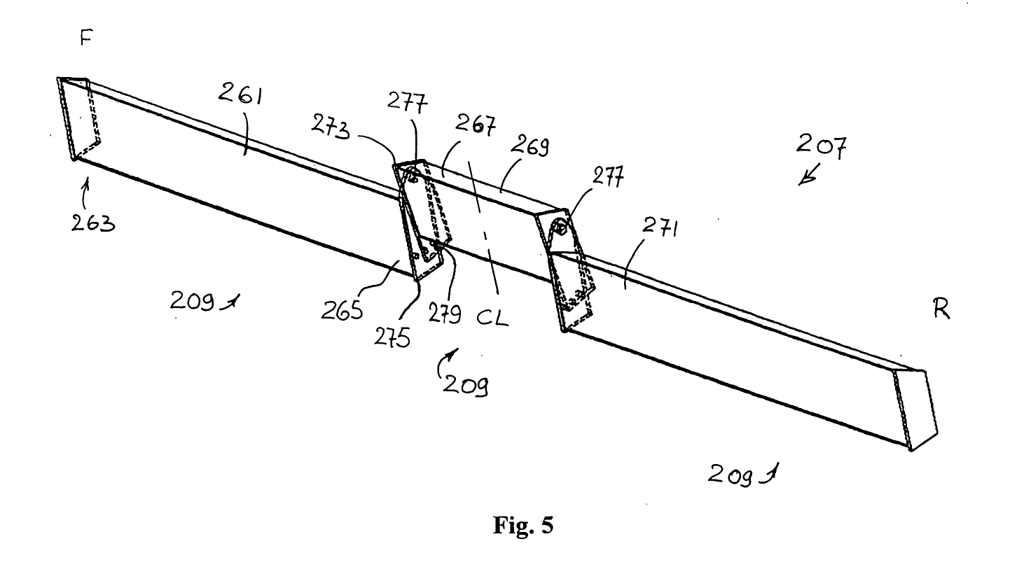

With reference to FIG. 5, the backbone 207 alone is shown as being built of three assembled beam segments 209, namely a front beam segment 261, with a free end 263 and a retained end 265 cantilevered to a front extremity 267 of middle beam segment 269. Likewise, in mirroring symmetry to a centerline CL of the middle beam segment 269, a rear beam segment 271, is also assembled to the middle beam segment 269 in the same manner. The three beam segments 209 are easily assembled and taken apart when desired, and since each separate division 213 is cantilevered to one segment 209 of the backbone 207, the divisions are easily assembled and disassembled. As an example, although well known in the art, the coupling of the front beam segment 261 to the middle beam segment 269 is briefly described.

As seen in FIG. 5, the middle beam segment 269 has an end plate 273 fixedly retained at the front extremity 267 thereof. A matching connecting plate 275 fixedly attached to the retained end 265 of the front beam segment 261, may be coupled to the corresponding end plate 273 in angularly adjustable position, and then fixed in rigid releasable retention. One pin pivot 277, or bolt pivot 277, common to both the end plate 273 and the connecting plate 275 permits mutual relative swivel, or pivoting. A lock bolt 279 permits to fixedly lock the front beam segment 261 in angular position relative to the middle beam segment 269. Else, or in addition, the end plate 273 and the connecting plate 275 may contain matching bores for coupling the front beam segment 261 to the middle beam segment 269 in determined discrete positions by help of bolts, or otherwise. With the lightweight embodiment 200, one pin pivot 277, or one bolt pivot 277, and one lock bolt 279 suffice for retaining and releasing the middle beam segment 269 from the front beam segment 261, and likewise for the rear beam segment 271.

The SLFD 201 thus permits to accommodate each one of the two side-divisions for in situ assembly to, and for in situ disassembly from, the mid-division.

Furthermore, pivoting of the front beam segment 261 permits to control the angle of groundward slope of the front section, which may be adjusted as desired. This adjustment permits to position the leading edge 245 of the front section 233 on the ground G or at any position higher up, spanning the whole range of levels of height from the ground up to at least the level of height of the leading edge 245 of the mid-section 235 of the upper portion 203. The same adjustment facility is operable independently for the front beam segment 261 and for the rear beam segment 271, hence for the leading edge 245 of both side sections 239. The SLFD 201 is thus configured to allow selection and independent adjustment of the level of height above the ground G of the leading edge 245 of each one of the side-sections 239.

It is noted that the middle beam segment 263 is coupled higher above both the front beam segment 261 and the rear beam segment 271, as is advantageous for accommodating the two side sections 239 to reach down to a lower level of height, closer to the ground G, and even almost on top thereof. In practice, the leading edge 245 of the side sections 239 is set to reside at a level of height of between 5 cm and 10 cm above the ground G, to penetrate below low-hanging branches of the foliage FOL and to avoid hitting the ground.

Similarly to the disassembly of the side sections 239, the mid-division 217 may also be disassembled if desired, but for the sake of transportation this is superfluous since the mid-section 235 is pivotable towards the mid-wall 225 on a pivot coupled to the middle beam 269 of the backbone 207. Hence, by coupling the mid-section 235 in pivotal fixable and releasable retention relative to the mid-wall 225, the mid-division 217 is foldable by pivoting thereof onto the mid-wall.

For transportation, it is thus possible to fully retract the telescopic boom 17, and then to swivel and close the mid-section 235 on, and in abutment with the mid-wall 225.

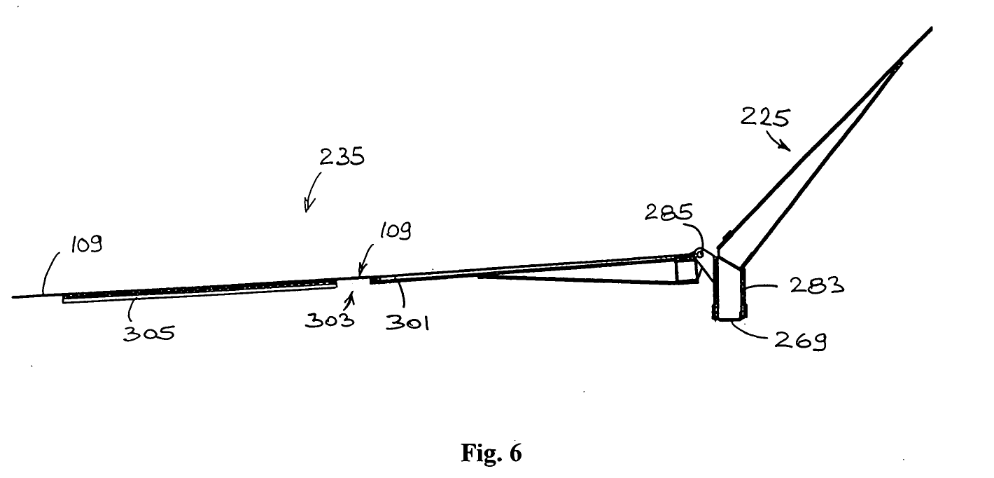

FIG. 6 shows a cross-section 283 of only the middle beam segment 269 to which the mid-wall 225 is fixedly attached. The flexible structure of both the mid-wall 225 and the mid- section 235 is clearly seen. Furthermore, the mid-section 235 is pivotally retained to the middle beam segment 269 by means well known to the art, such as a beam pivot 285, either a pin or a bolt, which may be releasably locked.

Still with reference to FIG. 6, the mid-section 235 is shown to be covered by a distal cover 301 in continuation of which, separated by a gap 303, resides a proximal cover 305 supported by the tree-shaking unit 9, not seen in FIG. 6. For example, a surface cover 109, or another pliable material is attached on top of the distal covers 301 and of the proximal covers 305, also covering the gap 303. Before folding the mid-section 235 onto the mid-wall 225, each proximal cover 305 is folded through 180° on top of the distal cover 301. Only then is the mid- section 235 pivoted on the beam pivot 285 and closed on the mid-wall 225. Other folding implementations are evidently possible.

Although not depicted in the Figs., the mid-section 235 is not necessarily kept shorter than the side sections 239, and is even easily also constructed as a flexible structure, from the backbone 207 down to the imaginary line joining the leading edge 245 of both side sections 239. When implemented as a flexible structure, the mid-section 235 may also be first folded over itself, and then closed against the mid-wall 225. Below a gap 157 left intentionally open for the passage therein of the tree-trunk TT on the proximal portion of the mid-section 235, a small panel may be coupled on top of each jaw 29 of the tree-trunk shaker 9, to appropriately deflect the fruit TRF groundward.

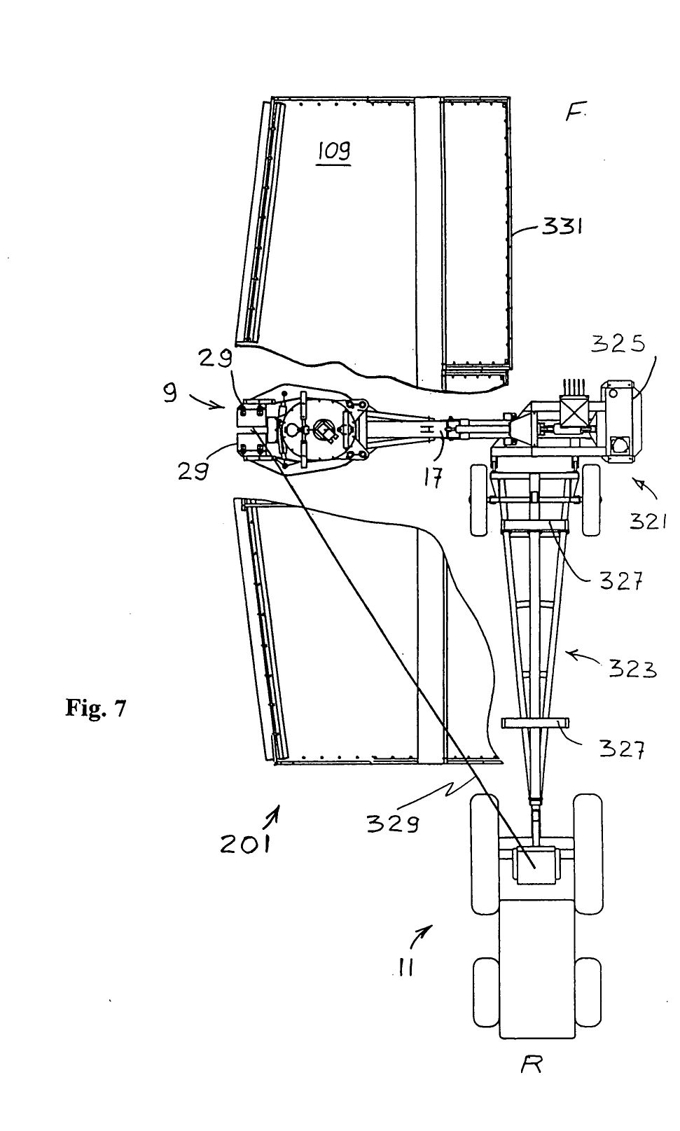

In FIG. 7, the SLFD 201, partially cut open to expose the tree-trunk shaker 9 and the telescopic boom 17, is shown supported in cantilever to a towed vehicle 321, which is towed by a towing boom 323 behind an automotive vehicle 11. By towing the SLFD 201 on a narrow and low-height towed vehicle 321, there are provided both a longer retraction path for the telescopic boom 17, before the SLFD 201 collides with the supporting vehicle, and a direct line of sight between the driver D, or operator D, not shown in the Figs, when seated on the towing automotive vehicle 11. Furthermore, the towing boom 323 is accommodated with section supports 327 for the transportation thereon of the side sections 239, either before or after harvesting.

Thus, the SLDF 201 permits to select the vehicle on which it is supported as a towed vehicle, to which the telescopic boom 17 is coupled in cantilever. The towed vehicle 321 is pulled in tow, or hitched to, an automotive vehicle 11 by help of a towing boom 323.

The tree-trunk shaker 9 and the telescopic boom 17 are supported on the towed vehicle 321 in the same manner as when mounted directly on an automotive vehicle 11. To counterbalance the weight of the tree-trunk shaker 9 mounted on the proximal free extremity 21 of the telescopic boom 17, a counterweight 325, such as a reservoir of hydraulic oil, is possibly attached to the attached extremity of the telescopic boom.

It is pointed out that an automotive vehicle 11 usually has a superstructure with a driver's cabin high above the ground G, to provide better sight and acclimatized working conditions to the driver. However, since the trailing edge 331 of the upper portion 203 of the SLFD 201 is a distally inclined structure, which is relatively high and therefore, the retraction path of the telescopic boom 17 is limited to prevent collision between the upper portion 203 and the automotive vehicle 11. It is therefore advantageous to utilize a towed vehicle 321 instead of an autonomous vehicle 11, the former presenting low height above the ground G. With a towed vehicle 321 supporting the telescopic boom 17, it becomes possible to retract the SLFD 201 after harvesting, further distally, thus away from the tree T, without danger of collision between the upper portion 203 and the towed vehicle 321.

By providing a long enough towing boom 323, the driver D, not shown in the Figs., which is seated on the automotive vehicle 11 higher above ground than the height of the low-height towed vehicle 321, has a direct line of sight 329 with the clamping jaws 29 of the tree-fruit shaker 9. Moreover, when sufficiently long and provided with appropriately located and accordingly dimensioned section supports 327, the towing boom 323 is configured for the transportation thereon of the side divisions 229.

It is thus by appropriately adapting the length of the towing boom 323 that a driver D, or an operator D, seated on the automotive vehicle 11, is provided with a view unobstructured by the upper portion 103 of the SLFD 101, or the upper portion 203 of the SLFD 201. In other words, the operator D is provided with a free line of sight 329 to allow visual observation of the tree-trunk shaker 9 mounted on the telescopic boom 17.
Operation of the Split Level Flexible Deflector SLFD

For harvesting a single tree T or a row of trees ROT, fruit collection equipment COL is first positioned in place on a first row side FRR of the ROT, opposite the tree T to be harvested. When deployed for operation, the collection equipment COL may abut the tree-trunk TT and extend on the first row side FRR from a tree before up to a tree behind the tree T.

When the harvesting system, or harvesting apparatus is brought to the field, the split-level flexible deflector SLFD unloaded, and in the case of the split-level flexible deflector SLFD 201, assembled and adjusted as described above. Further, the split-level flexible deflector SLFD is positioned on a second row side SCR of the ROT, opposite the tree T. Then, the telescopic boom 17 carrying the tree-trunk shaker 9 and the split-level flexible deflector SLFD is extended and the jaws 29 are clamped on the tree-trunk TT as low as possible above the ground G. The side sections, either 139 or 329, approach the tree-trunk TT at ground-grazing height above the ground G and pass below the low-hanging branches of the foliage FOL to reach over to the second row-side SCR and above at least a portion of the collection equipment COL. For the SLFD 201, the level of height of the leading edge above the ground G was adjusted independently a priori.

Should the split-level flexible deflector, SLFD 101 or SLFD 201, encounter an obstacle, then the ribs 107 deflect elastically and recover their original shape after retraction from contact with the obstacle.

When the tree-trunk TT is clamped, the tree T is harvested by shaking the tree-trunk with the tree-trunk shaker 9, whereby the tree-fruit TRF to fall onto the split-level flexible deflector SLFD and are deflected toward the ground G, and guided to roll onto the collection equipment COL. After harvesting of the tree T is completed, the harvesting system unclamps from the tree-trunk TT, the telescopic boom 17 is retracted, and the harvesting system is driven to a next tree. Meanwhile, the collection system COL gathers the tree-fruit TRF, and when done, also continues to the next tree.

When harvesting is completed and if desired, the split-level flexible deflector SLFD 201 is dismounted by disassembling the side divisions 229 from the mid-division 235, and the former are loaded and secured for transportation on the towing boom 323. Then, the mid-division 217 is folded and the telescopic boom 17 is retracted. The split-level flexible deflector SLFD 201 is now ready for transportation, together with the harvesting equipment.

While preferred embodiments of the invention have been described in detail, it should be apparent that many modifications and variations thereto are possible, all of which fall within the true spirit and scope of the invention as defined in the appended claims. For example, it is possible to attach the walls, namely the front wall 223, the mid-wall 225, and the rear wall 227, and the sections 231, to the backbone structure 111 and to the backbone 207 as separate detachable and connectable units, with or without angular adjustment of coupling. Furthermore, if so desired, both sides of the SLFD 201 may be covered with a cover 109. Moreover, it is possible to implement such enhancements with a variety of manufacturing methods employing different technologies for the coupling of the SLFD 101 and 201 to the telescopic boom 17, for the attachment of the walls and sections, and for the folding of various elements. It will be appreciated by persons skilled in the art that the present invention is not limited to what has been particularly shown and described hereinabove. Rather, the scope of the present invention is defined only by the claims, which follow.

1. A method for implementing a split level flexible deflector (SLFD) having an upper portion and a lower portion configured for receiving and guiding fruit toward the ground (G), the SLFD being coupled in perpendicular to a translating portion of a telescopic boom supporting a tree-trunk shaker and having a static portion cantilevered to a vehicle, the method comprising the steps of:
configuring the lower portion of the SLFD as three substantially aligned sections having one mid-section and one side section on each one of the two sides of the mid-section, each one section having a leading edge, and
positioning the leading edge of each one of the two side sections closer to the ground at a vertically spaced apart distance below and away from the leading edge of the mid-section, whereby the leading edge of each one of the two side sections resides at a selected level of height above the ground and closer thereto, and lower below the level of the leading edge of the mid-section.

2. The method according to claim 1, wherein:
the SLFD is configured to allow selection and independent adjustment of the level of height above the ground of the leading edge of each one of the side-sections.

3. The method according to claim 1, wherein:
the vehicle is selected as a towed vehicle,
the telescopic boom is configured for coupling in cantilever to the towed vehicle, and
the towed vehicle is pulled with a towing boom behind an automotive vehicle.

4. The method according to claim 3, wherein:
the length of the towing boom is adapted appropriately to provide an operator seated on the automotive vehicle with a view unobstructured by the upper portion of the SLFD, and
the operator is provided with a free line of sight to allow visual observation of the tree-trunk shaker mounted on the telescopic boom.

5. The method according to claim 3, wherein:
the SLFD is configured to have three separable substantially aligned divisions with one mid-division and one side-division on each one of the two sides of the mid-division,
each one of the two side-divisions is configured for in situ assembly to, and for in situ disassembly from, the mid-division, and
the towing boom is configured for transportation thereon of the side divisions.

6. The method according to claim 1, wherein:
the SLFD is configured into three separable substantially aligned divisions comprising one mid-division and one side-division on each one of the two sides of the mid-division, and
each one of the two side-divisions is configured for in situ assembly to, and for in situ disassembly from, the mid-division.

7. The method according to claim 6, wherein:
each one side division is coupled to the mid-division with fast-assembly and fast-disassembly fastening elements, whereby fast assembly and disassembly of each one of the side divisions is provided.

8. The method according to claim 6, wherein:
each one of the side-divisions is configured as a man-portable division.

9. The method according to claim 6, wherein:
the mid-division has a mid-section pertaining to the lower portion and a mid-wall pertaining to the upper portion, and
the mid-section is coupled in pivotal retention relative to the mid-wall, whereby the mid-division is foldable by pivoting thereof onto the mid-wall.

10. The method according to claim 9, wherein:
the telescopic boom supporting the SLFD is coupled in cantilever to a towed vehicle pulled by a towing boom hitched to an automotive vehicle,
the towing boom is configured for transportation thereon of the side divisions,
each one of the side-divisions is disassembled from the mid-division, which is then folded, and
the side-divisions is loaded onto the towing boom, whereby the SLFD is accommodated for transportation.

11. A split-level flexible deflector (SLFD) comprising a structure having an upper portion and a lower portion configured for receiving and guiding fruit toward the ground (G), the SLFD being coupled in perpendicular to a translating portion of a telescopic boom supporting a tree-trunk shaker and having a static portion cantilevered to a vehicle, the SLFD comprising:
the lower portion of the SLFD being configured as three substantially aligned sections having one mid-section and one side section on each one of the two sides of the mid-section, each one section having a leading edge, and
the leading edge of each one of the two side sections being positioned closer to the ground at a vertically spaced apart distance below and away from the leading edge of the mid-section, whereby the leading edge of each one of the two side sections resides at a selected level of height above the ground and closer thereto, and lower below the level of the leading edge of the mid-section.

12. The SLFD according to claim 11, wherein:
the SLFD is configured to allow independent adjustment of the height above the ground of the leading edge of each one of the side-sections.

13. The SLFD according to claim 11, wherein:
the vehicle is selected as a towed vehicle,
the telescopic boom is coupled in cantilever to the towed vehicle, and
the towed vehicle is pulled with a towing boom (323) behind an automotive vehicle (11).

14. The SLFD according to claim 13, wherein:
the length of the towing boom is adapted appropriately to provide an operator seated on the automotive vehicle with a view unobstructured by the upper portion of the SLFD, and
the operator is provided with a free line of sight to allow visual observation of the tree-trunk shaker mounted on the telescopic boom.

15. The SLFD according to claim 13, wherein:
the SLFD is configured into three separate substantially aligned divisions having one mid-division and one side-division on each one of the two sides of the mid-division,
each one of the two side-divisions is accommodated for in situ assembly to, and for in situ disassembly from, the mid-division, and
the towing boom is configured for transportation thereon of the side divisions.

16. The SLFD according to claim 11, wherein:
the SLFD is configured into three separate substantially aligned divisions comprising one mid-division and one side-division on each one of the two sides of the mid-division, and
each one of the two side-divisions is accommodated for in situ assembly to, and for in situ disassembly from, the mid-division.

17. The SLFD according to claim 16, wherein:
each one side division is coupled to the mid-division with fast-assembly and fast-disassembly fastening elements, whereby fast assembly and disassembly of each one of the side divisions is provided.

18. The SLFD according to claim 16, wherein:
each one of the side-divisions is configured as a man-portable division.

19. The SLFD according to claim 16, wherein:
the mid-division has a mid-section pertaining to the lower portion and a mid-wall pertaining to the upper portion, and
the mid-section is coupled in pivotal retention relative to the mid-wall, whereby the mid-division is foldable by pivoting thereof onto the mid-wall.

20. The SLFD according to claim 19, wherein:
the telescopic boom supporting the SLFD is coupled in cantilever to a towed vehicle pulled by a towing boom hitched to an automotive vehicle,
the towing boom is configured for transportation thereon of the side divisions,
each one of the side-divisions is disassembled from the mid-division, which is then folded, and
the side-divisions is loaded onto the towing boom, whereby the SLFD is configured for transportation.
